(19) United States
(12) Patent Application Publication
(10) Pub. No.: US 2026/0180325 A1
(43) Pub. Date: Jun. 25, 2026

(54) Systems and Methods of Interval Energy Disaggregation Utilizing Profile-Driven Non-Intrusive Load Monitoring

(71) Applicant: Rainforest Automation, Inc., Vancouver (CA)

(72) Inventors: Baran Cezayirlioglu, Port Coquitlam (CA); Christopher Stanley James Tumpach, Vancouver (CA)

(21) Appl. No.: 19/543,745

(22) Filed: Feb. 18, 2026

Related U.S. Application Data
(63) Continuation-in-part of application No. 18/324,032, filed on May 25, 2023, now Pat. No. 12,580,386.

(51) Int. Cl. H02J 3/00; B60L 53/62; H02J 3/38; H02J 13/12; H02J 101/22; H02J 103/30; H02J 105/12; H02J 105/42

(52) U.S. Cl. CPC H02J 3/004; B60L 53/62; H02J 3/381; H02J 13/12; H02J 2101/22; H02J 2103/30; H02J 2105/12; H02J 2105/42

(57) ABSTRACT

Systems and methods for interval energy disaggregation utilizing profile-driven non-intrusive load monitoring are provided. An example method includes determining whether a structure utilizes solar energy. If the structure utilizes solar energy, the overall aggregate data is disaggregated to produce a predicted solar production. The predicted solar production is extracted from an overall aggregate data of the structure. Then, the method continues with establishing appliance profiles, selecting a set of the appliance profiles, and disaggregating the non-solar aggregate data, to produce disaggregated data relating to at least one of AC energy consumption and EV (electric vehicle) consumption. The disaggregated data is provided to the customer or utility.

### CROSS REFERENCE TO RELATED APPLICATIONS

This application is a continuation-in-part of U.S. application Ser. No. 18/324,032 filed on May 25, 2023, entitled “Systems and Methods for Internal Energy Disaggregation Utilizing Machine Learning”, which is hereby incorporated by reference herein in their entirety, including all appendices and references cited therein, for all purposes.

### TECHNICAL FIELD

The present disclosure relates generally to energy disaggregation and, more particularly, to systems and methods for interval energy disaggregation by utilizing profile-driven non-intrusive load monitoring.

### BACKGROUND

Customarily, utility companies provide utility bills for the customers for payment of energy usage. Specifically, the utility bills indicate what is the total energy consumption of a customer's household for a given utility, whether it be gas, electricity, and the like, and the utility costs for the household's energy consumption. However, such traditional utility bills fail to provide a customer with the information that they require, in order for the customer to effectively manage or tailor their energy consumption to best suit their household's energy needs. Likewise, utility companies cannot presently obtain the consumption information of their customers which they require, in order to decide what approach best addresses the potential or current problems that may occur with their local grid.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for interval energy disaggregation utilizing profile-driven non-intrusive load monitoring. An exemplary method for interval energy disaggregation begins with determining whether the structure utilizes solar energy that is generated by a solar panel associated with a structure, based on customer data pertaining to a customer associated with the structure. The customer data comprises overall aggregate data of the structure generated by an advanced meter infrastructure of a utility. The overall aggregate data comprises consumption data regarding energy usage of the customer at the structure. Then, predicted solar production, if any, is extracted from the overall aggregate data of the structure, to produce non-solar aggregate data for the structure.

Next, appliance profiles for one or more of a plurality of appliances of the structure are established using a unified appliance profile schema. The unified appliance profile schema is configured to encapsulate all appliance-specific behavior in a persistent single, declarative profile structure. Then, a set of the appliance profiles is selected.

Based on the selected set of appliance profiles, the non-solar aggregate data is disaggregated, to produce disaggregated data relating to at least one of AC energy consumption and EV (electric vehicle) consumption. The disaggregation may comprise: detecting a session of a set of appliances based on the signals of the appliances; utilizing the selected set of appliance profiles to execute the post-processing of the signals of the set of appliances and cleaning of the session; and tracing results from the cleaning of the session, based on the one or more selected set of appliance profiles.

Finally, the disaggregated non-solar aggregate data is provided to the customer or the utility. The disaggregated non-solar aggregate data comprising at least one of the AC energy consumption, and the EV consumption associated with the structure.

Furthermore, an exemplary system for interval energy disaggregation utilizing for interval energy disaggregation utilizing profile-driven non-intrusive load monitoring is disclosed herein. The system includes a memory for storing executable instructions and a processor coupled to the memory. The processor is configured to execute the executable instructions. The executable instructions include determining whether the structure utilizes solar energy that is generated by a solar panel associated with a structure, based on customer data pertaining to a customer associated with the structure. The customer data comprises overall aggregate data of the structure generated by an advanced meter infrastructure of a utility. The overall aggregate data comprises consumption data regarding energy usage of the customer at the structure. Then, predicted solar production, if any, is extracted from the overall aggregate data of the structure, to produce non-solar aggregate data for the structure.

Next, appliance profiles for one or more of a plurality of appliances of the structure are established using a unified appliance profile schema. The unified appliance profile schema is configured to encapsulate all appliance-specific behavior in a persistent single, declarative profile structure. Then, a set of the appliance profiles is selected.

Based on the selected set of appliance profiles, the non-solar aggregate data is disaggregated, to produce disaggregated data relating to at least one of AC energy consumption and EV (electric vehicle) consumption.

Finally, the disaggregated non-solar aggregate data is provided to the customer or the utility. The disaggregated non-solar aggregate data comprising at least one of the AC energy consumption, and the EV consumption associated with the structure. The disaggregation may comprise: detecting a session of a set of appliances based on the signals of the appliances; utilizing the selected set of appliance profiles to execute the post-processing of the signals of the set of appliances and cleaning of the session; and tracing results from the cleaning of the session, based on the one or more selected set of appliance profiles.

A non-transitory computer readable medium for having embodied thereon instructions is also described, which when executed by a processor, perform steps of a method for interval energy disaggregation utilizing profile-driven non-intrusive load monitoring.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements.

FIG. 1 is a block diagram of a system for interval energy disaggregation utilizing machine learning, according to some example embodiments.

FIGS. 2A, 2B, and 2C are flow charts showing a method for interval energy disaggregation utilizing machine learning, according to an example embodiment.

FIG. 3 shows a computing system suitable for implementing embodiments of the present disclosure.

FIG. 4 is a block diagram of a system for interval energy disaggregation utilizing profile-driven non-intrusive load monitoring, according to some example embodiments.

FIGS. 5A and 5B provide a flow chart showing a method for interval energy disaggregation utilizing profile-driven non-intrusive load monitoring, according to an example embodiment.

FIG. 6 is a block diagram of an exemplary meter analytics engine pipeline, according to some example embodiments.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In general, the present disclosure is related to systems and methods for interval energy disaggregation by utilizing machine learning. These systems and methods are designed to estimate appliance-level consumption from advanced metering infrastructure (AMI) data, which aggregates energy consumption over intervals (which may be intervals of any duration, including but not limited to 15-minute intervals, 30-minute intervals, and hourly intervals). In other words, the systems and methods for interval energy disaggregation utilize the AMI data that is already generated and furnished by the utility (using meter data primarily used for utility billing purposes), in order to derive as much useful information for as many parties as possible. Thus, the systems and methods provided herein do not require any additional software or hardware implementations (e.g., a smart meter) at the utility level. The present disclosure supports a number of loads, including but not limited to Electric Vehicles (EVs), heating (e.g., baseboard heaters, space heaters, electric central furnaces, heat pump systems, and the like), cooling (e.g., window cooling units, electric central systems, heat pump systems and the like), water heating (e.g., resistive and heat pump systems), solar generation, always-on/baseline consumption, and refrigeration (e.g., fridges, freezers, combined units and the like).

Embodiments of the present disclosure may provide technological solutions for providing useful insights about what specific loads are utilized in a given structure and how much energy is being delivered for those loads in the structure. The structure may be any type of construction, such as a house, a building, a condominium, an apartment building, and the like. The systems and methods described herein can cover any major load, and the techniques provided herein can be utilized for larger appliances, such as heating, cooling, hot water, and electric vehicles. As used herein, the term “local grid” may refer to an electrical network installed in a residential structure (such as a house), a commercial structure (such as a commercial building), or any other defined physical structure or boundary. With the machine learning and optimization techniques disclosed herein, such insights can be made regarding the energy usage of the larger appliances for the structure. These insights can provide helpful information to both the customer (also referred to as an “end user”) whose household or structure is utilizing the energy resources, as well as to a given utility company supplying the energy resources to the structure.

The systems and methods described herein inform the customer what specifically in their structure/home is utilizing energy and how much energy is being delivered to meet the customer's needs that drive the rising costs of their utility bill. With this useful information provided by the present disclosure, the customer can become more aware of how much energy is being consumed by a given larger appliance and how to best tailor or manage their energy resources while still having the customer's energy consumption needs met. Also, with the data derived by the present disclosure, the customer can be furnished with recommendations regarding their energy resources. For example, based on the data provided by the present disclosure, a customer may be informed that their electrical heating unit is running often at night, and they can be provided a customized recommendation that with the installation of a smart meter, their electrical heating can be turned down at night while still meeting the customer's needs for a comfortable temperature throughout the night.

Also, the present disclosure provides useful data to a utility company that is interested in what customer loads are so that the utility company can then decide what are the best approaches to solve potential problems that may occur with their local grid. As an example, a transformer on a given street may be overloaded at certain times of a given day. With the present disclosure, the utility may determine that electric vehicles contribute to the overloading of the transformer based on the data provided by the systems and methods of interval energy disaggregation disclosed herein. As a result, the utility can decide what to deploy, in order to address the overload. For example, the utility may decide to shift the load and may also decide to provide energy-saving recommendations to their customers.

Furthermore, as electrification and penetration of renewables increase, utilities face infrastructure limitations and they encounter difficulty in anticipating and delivering generation capacity, as well as difficulties in grid planning due to a lack of transparency of these grid resources and the like. Understanding their customer's behaviors, as well as their load types and adoption trends, is of high importance to a utility for grid planning, program development, program monitoring, etc. A disaggregation system can be used for such a purpose, along with direct usage display and associated behavioral recommendations to the customer/end user.

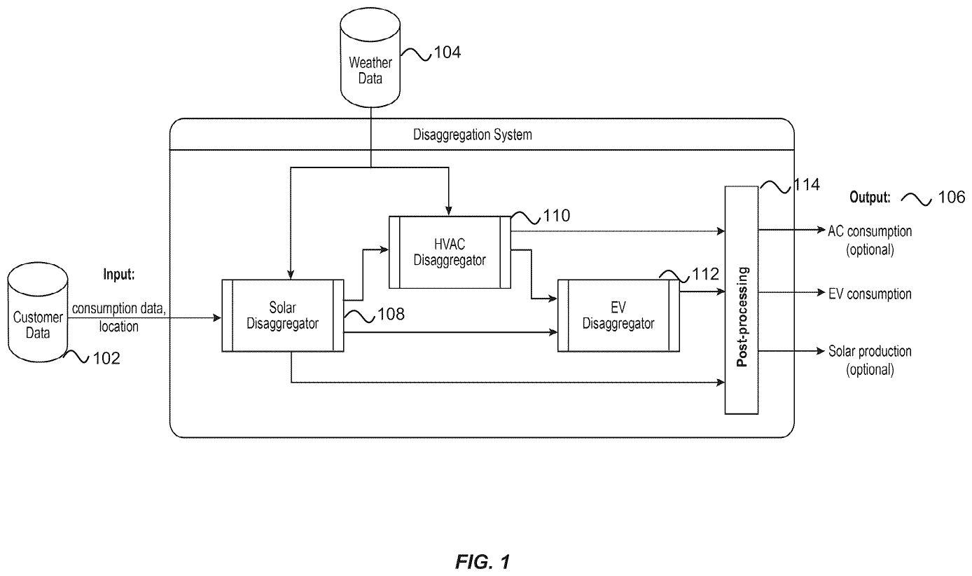

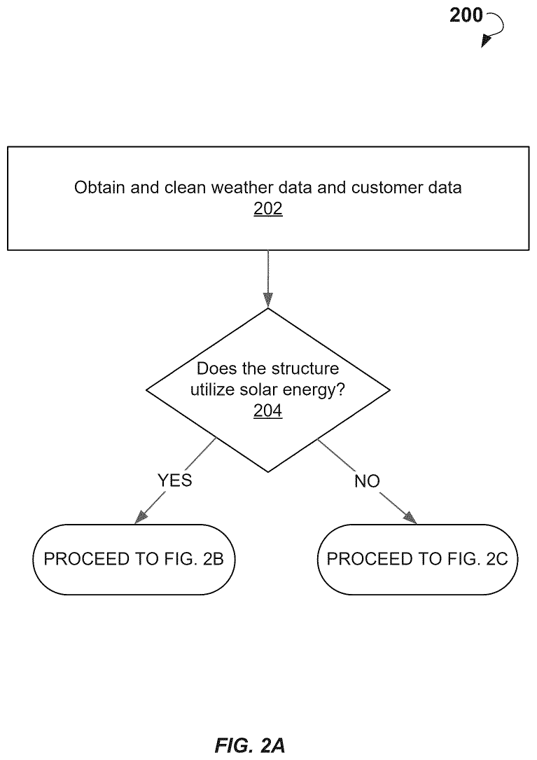

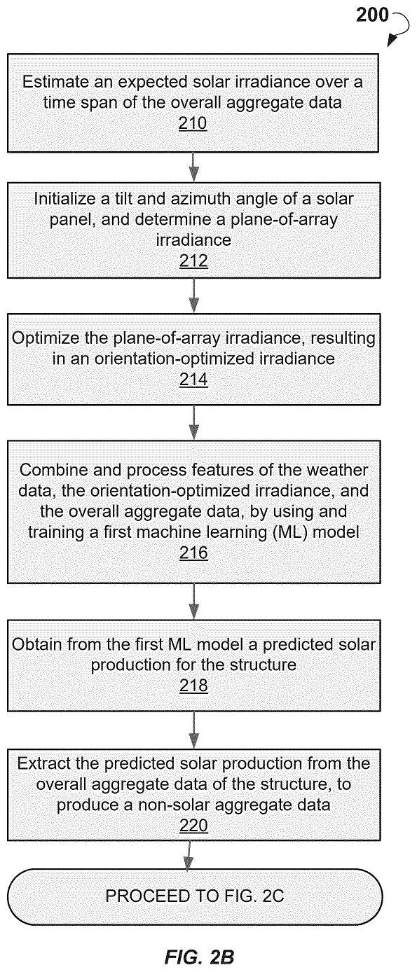

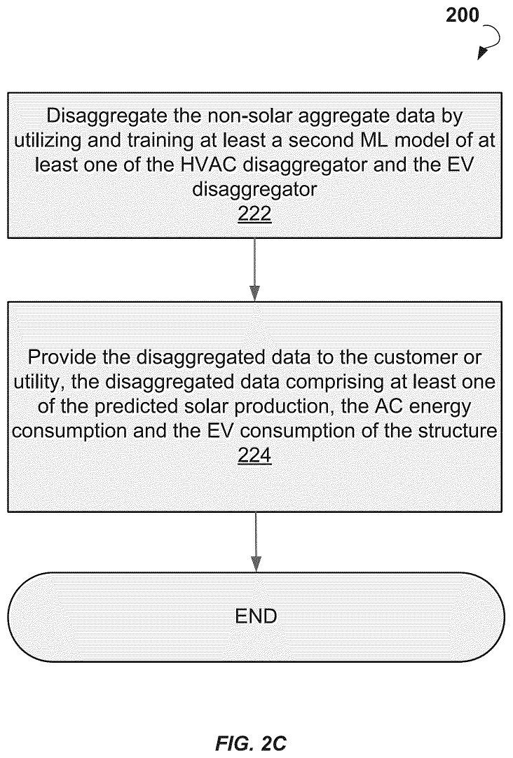

FIG. 1 is a block diagram of a system 100 for interval energy disaggregation utilizing machine learning, according to some example embodiments. The system 100 includes a processor and a memory for storing executable instructions to perform one or more methods of interval energy disaggregation utilizing machine learning. Such methods will be described later herein, in the context of FIGS. 2A, 2B and 2C.

Returning to FIG. 1, the system 100 comprises a disaggregation system designed to input data (such as customer data 102 and weather data 104) and, utilizing one or more machine learning models, output 106 of at least one disaggregated data regarding AC energy consumption, EV consumption, and solar production. Further details about the system are set forth in Appendices A and B, which are incorporated by reference herein in their entireties.

The customer data 102 and weather data 104 may be obtained from any datastore or database. Typically, the customer data 102 and weather data 104 is derived from data generated and furnished by a utility company, a weather service, and/or the customer itself. The customer data 102 relates to a customer who is associated with or living in a structure (such as a homeowner or an apartment tenant). The customer data 102 includes data regarding the geographic location of the structure. The customer data 102 also includes the overall aggregate data that is generated by an advanced meter infrastructure (AMI) of a utility. The overall aggregate data includes the consumption data regarding energy usage of the customer at the structure, including but not limited to, electrical, gas, and solar energy usage.

The system 100 includes a solar disaggregator 108, an HVAC disaggregator 110, and an EV disaggregator 112. In exemplary embodiments, the operations of the solar disaggregator 108, the HVAC disaggregator 110, and the EV disaggregator 112 are performed by one or more processors coupled with one or more memories. In some embodiments, the operations of the solar disaggregator 108, the HVAC disaggregator 110, and the EV disaggregator 112 are performed using one or more machine learning models.

Based on features of the customer data 102 and weather data 104, the solar disaggregator 108 disaggregates the overall aggregate data by using and training a first machine learning (ML) model, in order to produce an output of predicted solar production. The solar disaggregator 108 is utilized if it is determined that a given structure utilizes solar energy. If it is determined that the structure does not utilize solar energy, then the solar disaggregator 108 does not perform its data processing function on the overall aggregate data for the given structure. More information about the solar disaggregator is provided later herein and in Appendices A and B, which are both incorporated by reference in their entireties.

Notably, the system 100 provides a hierarchical structure for the solar disaggregator 108, the HVAC disaggregator 110, and the EV disaggregator 112. Also, notably, the solar disaggregator 108, the HVAC disaggregator 110, and the EV disaggregator 112 are interdependent, they are coupled with one another, and they rely upon each other, as depicted in FIG. 1. There is also interactivity and feedback between the solar disaggregator 108, the HVAC disaggregator 110, and the EV disaggregator 112 in that the machine learning models associated with the solar disaggregator 108, the HVAC disaggregator 110, and the EV disaggregator 112 leverage the hierarchical structure of the system 100.

Specifically, if the structure relies on solar power, the output of a first ML model that is used to perform the operations of the solar disaggregator 108 is considered the predicted solar production of the structure. This predicted solar production is extracted from the overall aggregate data of the structure, resulting in a non-solar aggregate data of the structure. By using non-solar aggregate data for the machine learning models of the downstream disaggregators (namely, the HVAC disaggregator 110, and the EV disaggregator 112), the accuracy of the output 106 data results of the system 100 is dramatically increased. Stated another way, if the structure utilizes solar power, the input data (the non-solar aggregate data) which is provided to the HVAC disaggregator 110 and the EV disaggregator 112 will not include the inaccuracies that occur when solar energy production is still included in the overall aggregate data that is inputted to the HVAC disaggregator 110 and the EV disaggregator 112. The removal of the solar component from the overall aggregate data is desired, so that the customer's structure may be treated as if it were a non-solar structure and the resulting predictions (the outputs of the disaggregation system 100 in FIG. 1), can be more accurate.

It should also be noted that if the structure does not utilize solar power, the overall aggregate data is already considered non-solar aggregate data to be used as data inputs by the HVAC disaggregator 110, and the EV disaggregator 112.

Turning now to FIGS. 2A-2C, these figures are flow charts showing a method 200 for interval energy disaggregation utilizing machine learning, according to an example embodiment. The method 200 can be performed by the system 100 described above with reference to FIG. 1.

The method 200 commences with block 202, where weather data and customer data are obtained from data sources. The weather and customer data are also cleaned. The weather data pertains to weather conditions of a location of a structure, while the customer data pertains to the customer associated with the structure. The customer data includes a geographic location of the structure and overall aggregate data generated by an advanced meter infrastructure of a utility. The overall aggregate data comprises consumption data regarding energy usage of the customer at the structure (also known as “household usage”). As shown on page 3 of Appendix B, the user data may include load data provided by the customer through a survey. The user data may also include feedback from the data and any data related to connected devices.

At block 204, a determination is made whether the structure utilizes solar power. This determination can be made based on the customer data. If it is determined that the structure utilizes solar power, then it is presumed that solar consumption data is still included in the overall aggregate data, and thus, the method 200 continues with the blocks provided in FIG. 2B. If at block 204 it is determined that the structure does not utilize solar power, then since solar consumption data is not a part of the overall aggregate data, the overall aggregate data is considered non-solar aggregate data, in which case the method 200 continues with the blocks as depicted in FIG. 2C.

If a determination is made at block 204 that the structure utilizes solar power, the method 200 continues with FIG. 2B, where the disaggregation of the overall aggregate data that is generated by the utility begins. By using and training a first machine learning (ML) model, the solar disaggregation of the overall aggregate data is accomplished by the solar disaggregator 108. Weather features are obtained based on the structure's general location.

At block 210, an expected solar irradiance is estimated over a time span (to: t) of the overall aggregate data of the structure. At block 212, a tilt a and azimuth angle θ of a solar panel of the structure are initialized, and a plane-of-array irradiance based on the location of the structure is determined. The location may include latitude and longitude coordinates of the structure. Specifically, the expected plane-of-array irradiance, Î, is computed for the customer's general latitude and longitude, (lₗₐₜ, lₗₒₙ), assuming the given solar tilt and azimuth angle, i.e.,

$$\hat{I} ( {t}_{0} : t ) = POA ( α , θ , {l}_{lat} , {l}_{l o n} , {t}_{0} : t ) .$$

At block 214, the tilt and azimuth angle of the solar panel are optimized, resulting in an orientation-optimized irradiance. Specifically, for the day, ta, in the aggregate data showing the largest total solar generation (i.e., the sunniest day relative to household usage), the solar panel tilt and azimuth angle are optimized by recomputing and scaling the expected irradiance and minimizing (in the least squares sense) the difference between the re-scaled irradiance, Î (t_{d}), and the household usage (given by x(t_{d})) during daytime hours. In other words:

$${{minimize}_{( α , θ ∈ ℝ )} ( \hat{\underline{I}} ( {t}_{d} ) - \vert x ( {t}_{d} ) \vert )}^{2} subject to \{ \begin{matrix}0 \leq α \leq 90 \\ 0 \leq θ \leq 360\end{matrix} , where$$

$$\underline{\hat{I}} ( {t}_{d} ) = \hat{I} ( {t}_{d} ) \cdot \frac{min ( x ( {t}_{d} ) )}{max ( \hat{I} ( {t}_{d} ) )}$$

At a high level, for solar disaggregation, based on the customer's general location, (provided in longitude and latitude coordinates), the expected irradiance at that specific location may be determined, which can be used with historical overall aggregate data. The solar disaggregation continues with an extra optimization step, where, in view of the aggregate consumption data, the solar panel tilt and the solar panel angle are tweaked or adjusted to decide what best matches the aggregated data with the expected irradiance. The first ML model then takes that optimized irradiance output value for a given interval (an interval that is generally between 15-60 minutes) with the overall aggregate data and various statistical features of the aggregate data including but not limited to the rolling hourly variance, the rolling hourly median, the rolling hourly min and max consumption, total daily kWh of net negative consumption, etc. Briefly, the first ML model (denoted f), of arbitrary form and parameterized by an n-dimensional vector, θ, is trained using ground truth solar production data (denoted by y), associated household usage data (denoted by x), and various predictive inputs such as that described above for orientation-optimized irradiance, weather features, and statistical features of the aggregate data (combined and denoted by the matrix X), according to the following:

$${θ}^{*} ← {minimize}_{θ ∈ {ℝ}^{n}} C ( f ( θ , x , X ) , y ) ,$$

where C is an arbitrary cost function defining the penalization of various prediction errors made by the model (i.e., comparing ŷ=f(θ, x, X) with y), a simple example of which might be the mean squared error. The minimization of the cost function is itself arbitrary but may involve a process such as stochastic gradient descent and may further involve monitoring errors on a random testing subset of the available input data. The parameters of the model satisfying the local minimum in the cost function according to the selected optimization process (denoted by θ*above) constitute a trained ML model and can be used with unseen consumption data (along with orientation-optimized irradiance, weather and extracted statistical features) to predict the interval solar generation.

Turning back to FIG. 2B, at block 216, the combination and processing of data features of the weather data, the orientation-optimized irradiance, and the overall aggregate data are performed, by using and training the first ML model as described above. At block 218, an output in the form of a predicted solar production of the solar panel(s) of the structure is obtained from the first ML model. Further details regarding solar disaggregation are provided in pages 3-6 of Appendix A, which is incorporated by reference herein in its entirety.

At this point, at block 220, the predicted solar production, if any, is extracted from the overall aggregate data of the structure, thereby resulting in non-solar aggregate data for the structure. Then, as shown in FIG. 2C, the method 200 continues at block 222 with disaggregating the non-solar aggregate data, based on the weather data and the customer data. The disaggregation may include utilizing at least a second ML model and possibly a third model, to produce disaggregated data relating to at least one of AC energy consumption and EV (electric vehicle) consumption.

For AC energy consumption, the HVAC disaggregation of the overall aggregate data is accomplished by the HVAC disaggregator 110 by using and training the second ML model. For HVAC disaggregation, where possible given sufficient historical data, the cooling and heating onset temperature is estimated for a given customer, so that the same ML model can be used to generate predictions of AC energy consumption, regardless of the temperature at which a home (structure)/user may respond to external temperature extremes. The process for this is as follows:
1. Initialize a cooling and heating onset temperature, e.g., T_{c}_{_{c}}=20° C. and Tₕ_{_{c}}=20° C., respectively.
2. Fit a polynomial relationship in daily consumption, yₕₒₘₑ, to external temperature, T, on either side of the onset temperatures, as well as between the onset temperatures (i.e., in the comfortable temperature range), rejecting outliers defined by a variance cut-off with respect to the initialized fit.
3. Simultaneously minimize the residual sum of squares between each polynomial relationship and the daily consumption in the temperature region by optimizing the onset temperatures.

Although higher degree relationships are contemplated with the present disclosure, an example of this process is shown below for the case where the polynomial relationship is degree 1 (i.e., a linear relationship):

$${\hat{y}}_{home} ( {T}_{{h}_{c}} , {T}_{{c}_{c}} ) = \{ \begin{matrix}{m}_{h} T + {b}_{h} , & T > {T}_{{h}_{c}} \\ {b}_{n} , & {T}_{{c}_{c}} \leq T \leq {T}_{{h}_{c}} \\ {m}_{c} T + {b}_{c} , & T < {T}_{cc}\end{matrix}$$

$${{minimize}_{( {T}_{{h}_{c}} , {T}_{{c}_{c}} ∈ ℝ )} ( {\hat{y}}_{home} - {y}_{home} )}^{2} subject to \{ \begin{matrix}{m}_{c} , {b}_{h} , {b}_{c} , {b}_{n} \geq 0 \\ {m}_{h} \leq 0 \\ {T}_{{h}_{c}} < {T}_{{c}_{c}}\end{matrix}$$

Notably, in the context of HVAC disaggregation, post-processing may be performed. Under the assumption that the dependency of daily consumption on temperature should be dominated by heating/cooling appliances, relationships as described above may be determined to provide a default daily HVAC consumption value (to be distributed across hours in the day in proportion to the relative household consumption in that hour), which is used when the prediction confidence of a second ML model (denoted model g) is low.

These onset temperatures are then used to classify each day as either cooling, heating, or neither. A separate ML model is trained to predict cooling and heating based on combined weather features as well as a set of 279 aggregate features, for example auto-correlation coefficients, measures of entropy, trend values, etc. In a similar way, the second ML model (denoted g), of arbitrary form and parameterized by an m-dimensional vector, φ, is trained using ground truth AC energy consumption data (denoted by y), associated household usage data (denoted by x), and various predictive inputs such as weather features and the statistical features mentioned above (combined and denoted by the matrix X), according to the following:

$${φ}^{*} ← {minimize}_{φ ∈ {ℝ}^{m}} C ( g ( φ , x , X ) , y \vert T \geq {T}_{{c}_{c}} ) ,$$

where C is an arbitrary cost function defining the penalization of various prediction errors made by the model (i.e. comparing y̅=g(φ, x, X) with y). The parameters of the model satisfying the local minimum in the cost function according to the selected optimization process (denoted by φ*above) constitute a trained ML model and can be used with unseen consumption data (along with weather and extracted statistical features) to predict the interval AC energy consumption. Further details regarding HVAC disaggregation are provided in pages 6-8 of Appendix A, which is incorporated by reference herein in its entirety.

Furthermore, still referring to block 222 of FIG. 2C, for EV (electric vehicle) energy consumption, the EV disaggregation of the overall aggregate data is accomplished by the EV disaggregator 112 (FIG. 1) by using and training utilizing at least a second ML model. For EV disaggregation, leveraged features of EV consumption patterns may include but are not limited to the large magnitude, consistency, and duration of EV-related loads relative to other household loads

There are three main tiers of EV chargers of concern.
1. Level 1 chargers (L1 hereafter): 12-15 A @120 V, ˜1.4-1.8 kW
2. Level 2 chargers (small, L2S hereafter): 15-20 A @240 V, ˜3.6-4.8 kW
3. Level 2 chargers (large, L2L hereafter): 24+A @ 240 V, ˜5.8+kW

Note that these current limits can be imposed by the EV supply equipment (EVSE, the charger), or by the EV itself (called the power acceptance, related to the onboard AC-DC converter). The premise of EV detection may be summarized as follows:

Where inferred HVAC permits, check that the aggregate consumption exceeds that expected by each given tier of L2L, L2S, and L1 consumption ranges for a minimum duration consistent with the charging rate (e.g., for 15 minute interval data: L2L≥30 minutes, L2S≥1 hour, L1≥6 hours) given baseline household usage. These cut-offs are somewhat arbitrary, but are chosen to maximize capture of battery EV and large capacity plug-in hybrid EV charging sessions, while minimizing false positive risk at the given data resolution. If potential EV charging is detected with reasonable confidence and regularity, the power level of the EVSE is re-estimated using the detected sessions.

The steps of EV disaggregation are as follows:
1. Determine the baseline usage for the structure. Baseline usage is what is meant by (in the preceding paragraph) “check that the aggregate consumption exceeds that expected by each given tier . . . given baseline household usage”: The threshold for EV detection should include the baseline aggregate consumption, which can be large for some structures. For example, if a structure has always-on loads constituting an estimated 1 kWh of energy at each 15-minute interval, the consumption that which might be inferred to be an EV to be contributing to the aggregate consumption should be approximately 1 kWh higher. This baseline usage can depend on the season, the day of week, the hour of the day, etc. For this reason, the baseline usage is modeled as sinusoidal, and optimized in the least-squares sense the phase and amplitude in weekly blocks to local minima (of order 3) in the aggregate consumption signal. This baseline usage is then incremented by a large fraction of the expected consumption value of the EV tier of interest (e.g., 80% of 0.95 kWh per 15 minute interval for L2S), which is then used as the threshold for EV detection.
2. Determine the aggregate regions exceeding that threshold subject to the duration conditions described above. Satisfactory aggregate regions are qualified as candidates for an EV charging session.

Furthermore, post-processing may occur to correct any overlap across the inferred consumption for the main tiers of EV chargers previously discussed. Furthermore, techniques of confidence prediction and a binary check may be instrumental for post-processing of EV disaggregation. With confidence prediction, for each week of aggregate data, a set of descriptive statistics is generated. For example, these descriptive features may include the inter-quartile range of household usage over the week, the baseline consumption, the proportion of time spent over the EV detection threshold described above, the degree of correlation of consumption with external temperature, etc. In a similar fashion as that described for both solar and AC disaggregation, a third ML model (denoted h) of arbitrary form and parameterized by an r-dimensional vector, φ, is trained to output an expected relative over-prediction error of inferred EV charging using ground truth EV over-prediction error (denoted \tilde{e}, this error is determined by comparing known EV charging (denoted by y) with disaggregated EV charging (denoted by ŷ) using the EV disaggregation method described to this point but not further. In other words,

$$\tilde{e} = \frac{\hat{y} - y}{y} ,$$

where ŷ≥y>0). The model h uses the known over-prediction error, \tilde{e}, the household or structure consumption data (denoted by x), and the descriptive features of the household usage data as described above (combined and denoted by the matrix X), and is trained according to the following:

$${φ}^{*} ← {minimize}_{ϕ ∈ {ℝ}^{r}} C ( h ( ϕ , x , X ) , \tilde{e} ) ,$$

where C is an arbitrary cost function defining the penalization of various prediction errors made by the model (i.e. comparing ê=h(φ, x, X) with \tilde{e}). The parameters of the model satisfying the local minimum in the cost function according to the selected optimization process (denoted by φ* above) constitute a trained ML model and can be used with unseen consumption data (along with weather and extracted statistical features) to anticipate the over-prediction error on unseen data (and thereby estimate confidence). In other words, the set of descriptive statistics is passed to a trained ML model trained on those features, and the ML model outputs an expected over-prediction error. When the expected over-prediction error for a given week exceeds a given threshold or tolerance, that week of aggregate data is discarded. Then, the median predicted EV consumption is carried forward to those discarded weeks of aggregate data.

This ML model was developed using synthetically generated EV charging behaviours, injected into a large variety of aggregate data conditions. Then, a discard will be done of the weeks for which the predicted error exceeds some tolerance. Depending on the binary check described below, carry forward the median weekly predicted EV consumption to the discarded weeks.

A binary check is for determining whether an EV charger is present or not in the historical data provided. A binary check is useful both as an independent output as well as to inform the inferred consumption values. In the process of confidence prediction described above, the remaining data after discarding weeks with low confidence is used to enforce a minimum and maximum number of monthly inferred charge sessions. Any inferred EV consumption is zeroed if this check fails, and any discarded weeks have the median weekly EV consumption imputed if this check succeeds. The assumption here is that if there is sufficient confidence in inferring EV consumption in some minimum duration of historical data, the EV charging is treated as approximately behaviorally constant over weekly scales.

Hence, for EV disaggregation, a threshold for EV detection includes a baseline aggregate usage of the structure. Also, for EV disaggregation, techniques of confidence prediction and a binary check (as described above) may be applied. Further details regarding EV disaggregation are provided in pages 8-12 of Appendix A, which is incorporated by reference herein in its entirety.

As mentioned earlier, the solar disaggregator 108, the HVAC disaggregator 110, and the EV disaggregator 112 of the system 100 (FIG. 1) are interdependent and related to each other. An example of this interdependency is demonstrated in EV disaggregation. Specifically, the inferred HVAC contribution to the overall aggregate data (of household usage) is passed or otherwise transmitted to the EV disaggregator. This may be seen as a feedback loop, such that the system 100 (FIG. 1) trains and learns based on the hierarchical structure. The inferred HVAC contribution to the overall aggregate data is used in the following way to post-process inferred EV charging sessions:
a. For inferred EV sessions, check whether the inferred HVAC over the duration compensates for an appreciable fraction of the energy consumed during that interval.
b. The “appreciable fraction” is determined as a likelihood cutoff for the residual between real household usage and ground truth HVAC usage for a large number of structures.
c. In other words, when the residual between the aggregate consumption and inferred HVAC consumption during an inferred EV session is large compared to what has been seen in real datasets, it is likely that the EV session is correct, and that the inferred HVAC should be adjusted to accommodate that session.

Several other aspects of the present disclosure benefit from iterative feedback loops, particularly as the amount of historical data grows. One such aspect is the iterative estimation of the baseline consumption of the structure, which is used to provide more accurate estimates of EV charging sessions as well as the power draw of any EV chargers present. Another aspect is the estimation of heating and cooling onset temperatures, as well as in the optimization of solar panel orientation if applicable. As additional data becomes available, the system will converge to stable estimates of these and other quantities.

The systems and methods described herein may further benefit from the feedback of known charging patterns given user connectivity in the form of communicating EV supply equipment or communicating EVs. Despite EV disaggregation being unnecessary for these users, the associated ground truth EV charging data can be used with the inferred EV charging activity to provide ongoing training for the confidence model h to be applied globally across users.

The invention may further benefit from the feedback of approximated HVAC operating state for users with communicating thermostat systems. This can be used to directly inform the AC disaggregation and therefore have direct improvements on the EV disaggregation process.

Finally, at block 224, the disaggregated data is provided to the customer or utility. The disaggregated data includes at least one or more of the predicted solar production, the AC energy consumption, and the EV consumption of the structure. The disaggregated data may be displayed on a display of a computing device of the customer or utility.

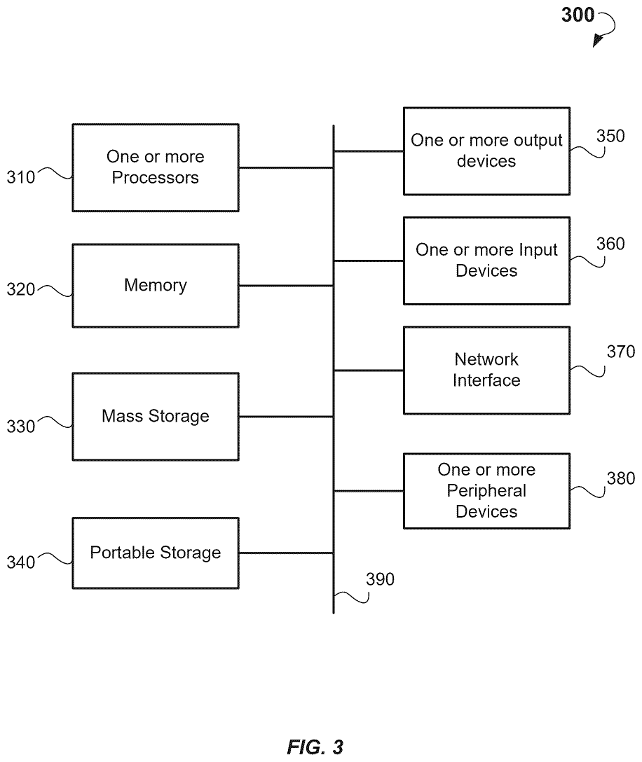

FIG. 3 illustrates an exemplary computing system 300 that can be used to implement embodiments described herein. The computing system 300 can be implemented in the context of the disaggregation system 100 (FIG. 1). The exemplary computing system 300 of FIG. 3 may include one or more processors 310 and memory 320. Memory 320 may store, in part, instructions and data for execution by the one or more processors 310. Memory 320 can store the executable code when the exemplary computing system 300 is in operation. The exemplary computing system 300 of FIG. 3 may further include a mass storage 330, portable storage 340, one or more output devices 350, one or more input devices 360, a network interface 370, and one or more peripheral devices 380.

The components shown in FIG. 3 are depicted as being connected via a single bus 390. The components may be connected through one or more data transport means. The one or more processors 310 and memory 320 may be connected via a local microprocessor bus, and the mass storage 330, one or more peripheral devices 380, portable storage 340, and network interface 370 may be connected via one or more input/output buses.

Mass storage 330, which may be implemented with a magnetic disk drive or an optical disk drive, is a non-volatile storage device for storing data and instructions for use by a magnetic disk or an optical disk drive, which in turn may be used by one or more processors 310. Mass storage 330 can store the system software for implementing embodiments described herein for purposes of loading that software into memory 320.

Portable storage 340 may operate in conjunction with a portable non-volatile storage medium, such as a compact disk (CD) or digital video disc (DVD), to input and output data and code to and from the computing system 300 of FIG. 3. The system software for implementing embodiments described herein may be stored on such a portable medium and input to the computing system 300 via the portable storage 340.

One or more input devices 360 provide a portion of a user interface. The one or more input devices 360 may include an alphanumeric keypad, such as a keyboard, for inputting alphanumeric and other information, or a pointing device, such as a mouse, a trackball, a stylus, or cursor direction keys. Additionally, the computing system 300 as shown in FIG. 3 includes one or more output devices 350. Suitable one or more output devices 350 include speakers, printers, network interfaces, and monitors.

Network interface 370 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 370 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a Universal Serial Bus.

One or more peripheral devices 380 may include any type of computer support device to add additional functionality to the computing system. The one or more peripheral devices 380 may include a modem or a router.

The components contained in the exemplary computing system 300 of FIG. 3 are those typically found in computing systems that may be suitable for use with embodiments described herein and are intended to represent a broad category of such computer components that are well known in the art. Thus, the exemplary computing system 300 of FIG. 3 can be a personal computer, handheld computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, systems and methods for interval energy disaggregation utilizing machine learning are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

### Profile-Driven Non-Intrusive Load Monitoring

In general, further embodiments of the present disclosure are related to systems and methods for interval energy disaggregation by utilizing profile-driven non-intrusive load monitoring (hereinafter sometimes referred to as “non-intrusive load monitoring” or “NILM”). The systems and methods utilizing profile-driven non-intrusive load monitoring as described herein disaggregate whole-building electricity consumption into individual appliance-level energy usage without requiring sub-metering or smart plugs. The exemplary systems and methods represent a significant advancement in non-intrusive load monitoring through its unified, declarative approach to appliance definition. By centralizing all appliance-specific behavior in profile dataclasses and providing bidirectional registry access, the exemplary system achieves maintainability and extensibility unprecedented in NILM solutions. The present disclosure describes Gaussian Mixture Model-based threshold refinement (which adapts detection threshold to actual data distribution rather than fixed values), building-size adaptive validation (which prevents false negatives in large buildings), temperature-aware active days (which calculates “active days” based on temperature suitability), and suggestion-based promotion. The Gaussian Mixture Model (GMM) is a statistical model for identifying energy level clusters. All of these work together to deliver accurate disaggregation across diverse building types while maintaining full explainability. Also, the exemplary system's modular architecture enables straightforward extension to new appliance types and building configurations, making it suitable for both research advancement and commercial deployment.

Like the systems and methods that were described earlier herein, these further systems and methods are designed to estimate appliance-level consumption from advanced metering infrastructure (AMI) data, which aggregates energy consumption over intervals (which may be intervals of any duration, including but not limited to 15-minute intervals, 30-minute intervals, and hourly intervals). In other words, the systems and methods for interval energy disaggregation utilize the AMI data that is already generated and furnished by the utility (using meter data primarily used for utility billing purposes), in order to derive as much useful information for as many parties as possible. The present disclosure supports a number of loads, including but not limited to Electric Vehicles (EVs), heating (e.g., baseboard heaters, space heaters, electric central furnaces, heat pump systems, and the like), cooling (e.g., window cooling units, electric central systems, heat pump systems and the like), water heating (e.g., resistive and heat pump systems), solar generation, always-on/baseline consumption, and refrigeration (e.g., fridges, freezers, combined units and the like).

Non-Intrusive Load Monitoring (NILM) aims to disaggregate total building electricity consumption into individual appliance usage using only the main meter signal. In contrast to the teachings of the present disclosure, traditional approaches face several challenges:
1. Heterogeneous Appliance Behavior: Different appliance types exhibit vastly different operational patterns (continuous, cycling, burst, variable), energy ranges, and environmental sensitivities.
2. Building Diversity: A water heater consuming 1 kWh in a 30 kWh/day residential building represents 3.3% of energy, but the same absolute value in a 300 kWh/day commercial building represents only 0.33%. But both should be detected.
3. Appliance Conflicts: Certain appliances cannot physically coexist (e.g., gas furnace and electric furnace), while others have complex temporal relationships (e.g., heat pump heating versus cooling modes).
4. False Positive Control: High correlation between different appliance detections can lead to double-counting energy or attributing baseline load to multiple appliances.
5. Maintainability: Traditional systems embed appliance-specific logic throughout the codebase, making modifications error-prone and difficult to audit.

Also, conventional systems have limitations that pose technological obstacles. For instance, conventional systems have hardcoded parameters of thresholds and validation logic scattered across detection and post-processing code. Such hardcoded parameters make conventional systems rigid and not easy to modify, such as in the case when a new appliance profile must be added or an existing appliance profile is to be removed. Also, conventional systems are entrenched with inflexible relationships since such systems require manual coding of every appliance interaction. Also, existing systems require building-specific tuning, which requires separate model configurations for residential structures versus commercial buildings. Furthermore, conventional systems provide poor explainability since black-box machine learning models often provide no insight into why a detection occurred or was rejected. In contrast to conventional systems, the exemplary systems of the present disclosure provide detection decision that is traceable. Examples of this are:
Reason(s) why a detection made: “Energy exceeded refined threshold (0.45 kWh>0.32 kWh baseline+0.08 margin)”
Reason(s) why an appliance or threshold was rejected: “low_confidence (0.52<0.60)” or “mutually_exclusive_with gas_furnace (overlap=0.72)”
Reason(s) why an appliance was boosted or promoted: “suggested by Heat Pump Heating Mode (confidence 0.55+0.25 boost=0.80)”

Furthermore, the present disclosure includes providing a user-friendly explanation of what the exemplary systems and methods determine. For instance, in some embodiments, a customer or a utility may want an audit trail that explains the tracing of all appliance behavior to appliance profile definition. The present disclosure provides the means to generate the audit trail as requested.

The NILM systems and methods of the present disclosure described herein address all these limitations and obstacles and more. Specifically, in comparison with conventional black-box machine learning systems, the systems and methods of the present disclosure achieve high accuracy while maintaining explainability and configurability. These are achieved with the assistance of the following components of the exemplary systems of the present disclosure:
1. Unified Appliance Profile Schema or Profile-Driven Architecture: A comprehensive dataclass-based profile system that encapsulates all detection, validation, relationship, and environmental parameters for each appliance type in a single source of truth. Conventional systems scatter appliance-specific logic across detection, validation, and post-processing code, making maintenance difficult and error-prone. This profile schema solves these problems by centralizing all appliance behavior in a single appliance profile dataclass with 30+parameters covering:
Detection (energy ranges, thresholds, cycle patterns)
Environmental adaptation (temperature, seasonal, time-of-day effects)·
Validation (activations, energy fractions, confidence)
Relationships (exclusivity, dependencies, suggestions)
Conflict resolution (overlap tolerance, correlation tolerance)

Thus, advantageously, the profile schema allows for adding or modifying an appliance which only requires changing the appliance's profile definition. As a result of this change, all downstream behavior automatically adapts.
2. Bidirectional Profile Registry: A central registry enabling O(1) lookup in both directions: profile name→column name→category, enabling automatic propagation of profile changes throughout the pipeline. Conventional pipelines need to look up appliance metadata from column names (detection) and resolve profile name references (relationships). In contrast, this bidirectional profile registry of the present disclosure provides O(1) bidirectional lookup:
Forward: profile.name→column name→category
Reverse: column name→profile→name

Advantageously, this bidirectional profile registry decouples components, enables category-based operations, and ensures consistent naming throughout the pipeline.
3. Multi-Stage Statistical Detection Engine: A four-stage detection pipeline using adaptive baseline calculation, Bayesian Gaussian Mixture Model (GMM) threshold refinement, intelligent session detection, and profile-aware validation.
4. Declarative Relationship Framework: Profile-defined relationship constraints (mutual exclusivity, dependencies, incompatibilities, suggestions) that are automatically enforced during conflict resolution. Conventional systems were hampered with appliance relationships (e.g., “heat strip requires heat pump”) that were hardcoded as validation rules, requiring code changes for new relationships. With the declarative relationship framework, relationships can be declared in profile metadata. An example of this is as follows:

```
heat_strip_profile:
    requires_presence_of: “Heat Pump Heating Mode”
  mutually_exclusive_with: [“Electric Furnace”, “Gas Furnace”]
```

Thus, advantageously, with the declarative relationship framework, relationships are automatically validated without custom code. New relationships require only appliance profile updates.
5. Building-Size Adaptive Validation: Automatic scaling of detection thresholds based on building consumption characteristics, enabling a single set of profiles to work across residential, commercial, and industrial buildings.

Embodiments of the present disclosure provide technological solutions for providing useful insights about what specific loads are utilized in a given structure and how much energy is being delivered for those loads in the structure. The structure may be any type of construction, such as a house, a building, a condominium, an apartment building, and the like. The systems and methods described herein can cover any major load, and the techniques provided herein can be utilized for larger appliances, such as heating, cooling, hot water, and electric vehicles. As used herein, the term “local grid” may refer to an electrical network installed in a residential structure (such as a house), a commercial structure (such as a commercial building), or any other defined physical structure or boundary. With the processes and techniques disclosed herein, such insights can be made regarding the energy usage of the larger appliances for the structure. These insights can provide helpful information to both the customer (also referred to as an “end user”) whose household or structure is utilizing the energy resources, as well as to a given utility company supplying the energy resources to the structure.

The systems and methods described herein inform the customer what specifically in their structure/home is utilizing energy and how much energy is being delivered to meet the customer's needs that drive the rising costs of their utility bill. With this useful information provided by the present disclosure, the customer can become more aware of how much energy is being consumed by a given larger appliance and how to best tailor or manage their energy resources while still having the customer's energy consumption needs met. Also, with the data derived by the present disclosure, the customer can be furnished with recommendations regarding their energy resources. For example, based on the data provided by the present disclosure, a customer may be informed that their electrical heating unit is running often at night, and they can be provided a customized recommendation that with the installation of a smart meter, their electrical heating can be turned down at night while still meeting the customer's needs for a comfortable temperature throughout the night.

Also, the present disclosure provides useful data to a utility company that is interested in what customer loads are so that the utility company can then decide what are the best approaches to solve potential problems that may occur with their local grid. As an example, a transformer on a given street may be overloaded at certain times of a given day. With the present disclosure, the utility may determine that electric vehicles contribute to the overloading of the transformer based on the data provided by the systems and methods of interval energy disaggregation disclosed herein. As a result, the utility can decide what to deploy, in order to address the overload. For example, the utility may decide to shift the load and may also decide to provide energy-saving recommendations to their customers.

Furthermore, as electrification and penetration of renewables increase, utilities face infrastructure limitations and they encounter difficulty in anticipating and delivering generation capacity, as well as difficulties in grid planning due to a lack of transparency of these grid resources and the like. Understanding their customer's behaviors, as well as their load types and adoption trends, is of high importance to a utility for grid planning, program development, program monitoring, etc. A disaggregation system can be used for such a purpose, along with direct usage display and associated behavioral recommendations to the customer/end user.

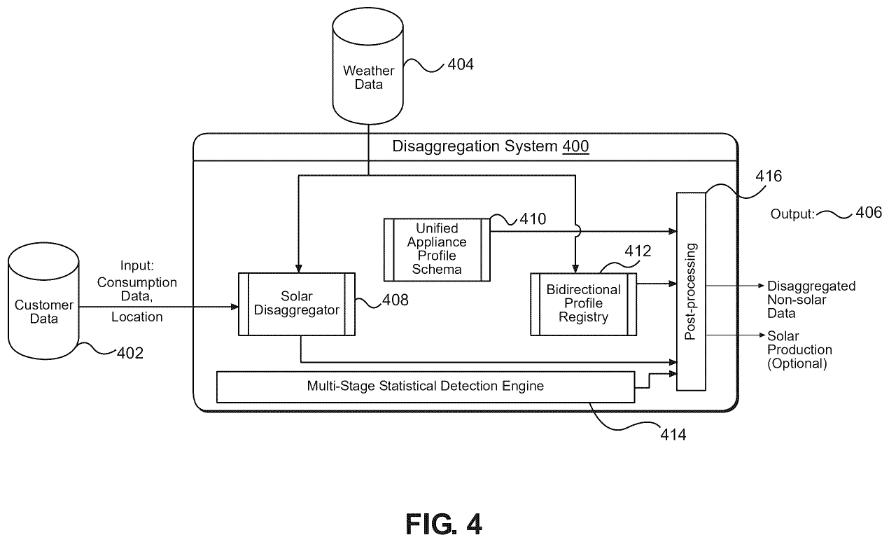

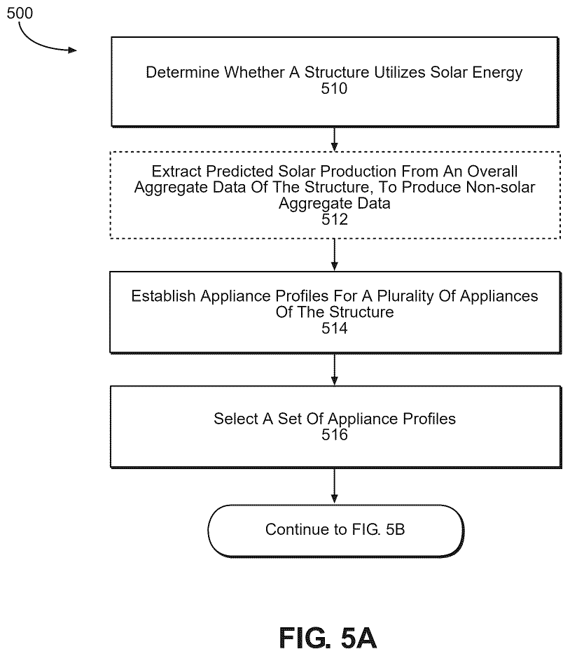

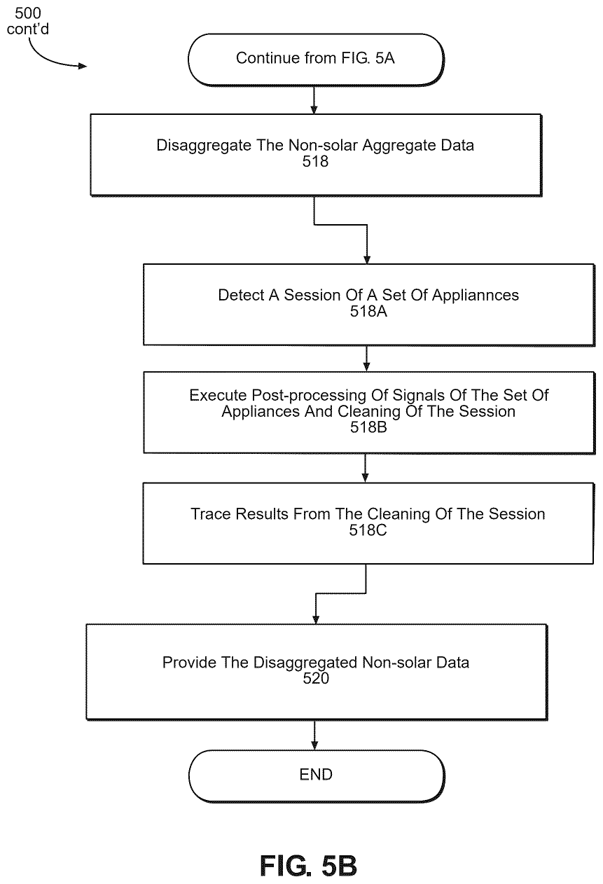

FIG. 4 is a block diagram of a system 400 for interval energy disaggregation utilizing profile-driven non-intrusive load monitoring, according to some example embodiments. The system 400 includes a processor and a memory for storing executable instructions to perform one or more methods of interval energy disaggregation utilizing profile-driven non-intrusive load monitoring. Such methods will be described later herein, in the context of FIGS. 5A and 5B.

Returning to FIG. 4, the system 400 comprises a disaggregation system designed to input data (such as customer data 402 and weather data 404) and, utilizing load monitoring, output 406 of at least one disaggregated data regarding non-solar production data (such as AC energy consumption) and optionally data regarding solar production.

The customer data 402 and weather data 404 may be obtained from any datastore or database. Typically, the customer data 402 and/or the weather data 404 are derived from data generated and furnished by a utility company, a weather service, and/or the customer itself. The customer data 402 relates to a customer who is associated with or living in a structure (such as a homeowner or an apartment tenant). The customer data 402 includes data regarding the geographic location of the structure. The customer data 402 also includes the overall aggregate data that is generated by an advanced meter infrastructure (AMI) of a utility. The overall aggregate data includes the consumption data regarding energy usage of the customer at the structure, including but not limited to, electrical, gas, and solar energy usage.

The disaggregation system 400 includes a solar disaggregator 408, a unified appliance profile schema 410, a bidirectional profile registry 412, and a multi-stage statistical detection engine 414. In some embodiments, the operations or functions of the solar disaggregator 408, the unified appliance profile schema 410, the bidirectional profile registry 412, and the multi-stage statistical detection engine 414 are associated with or accomplished by one or more processors coupled with one or more memories.

Based on features of the customer data 402 and the weather data 404, the solar disaggregator 408 disaggregates the overall aggregate, in order to produce an output of predicted solar production. The solar disaggregator 408 is utilized if it is determined that a given structure utilizes solar energy. A non-limiting example of a solar disaggregator is described earlier herein. If it is determined that the structure does not utilize solar energy, then the solar disaggregator 408 does not perform its data processing function on the overall aggregate data for the given structure.

The unified appliance profile schema 410 is configured to encapsulate all appliance-specific behavior in a persistent single, declarative profile structure. In some embodiments, once an appliance profile is established using the unified appliance profile schema 410, the appliance profile persists or follows the appliance such that parameters for each appliance type remain with the appliance. Such parameters can be modified or updated, but they are persistent and cannot be removed from the appliance profile. Specifically, the unified appliance profile schema 410 encapsulates all detection, validation, relationship and environmental parameters for each appliance type in a single source of truth. The bidirectional profile registry 412 provides O(1) lookup in both directions, enabling automatic propagation of profile changes throughout the pipeline. The multi-stage statistical detection engine 414 implements a detection pipeline with profile-driven behavior at each stage. In some embodiments, the multi-stage statistical detection engine 414 utilizes adaptive baseline, GMM threshold refinement, and profile-aware validation.

Notably, the system 400 depicts a relationship among the unified appliance profile schema 410, the bidirectional profile registry 412, and the multi-stage statistical detection engine 414. In some embodiments, the unified appliance profile schema 410, the bidirectional profile registry 412, and the multi-stage statistical detection engine 414 are interdependent, and they rely upon or work with each other, as depicted in FIG. 4. There are also aspects of interactivity and feedback between one or more of the unified appliance profile schema 410, the bidirectional profile registry 412, and the multi-stage statistical detection engine 414, which will be discussed in greater detail later herein.

If the structure relies on solar power, the output of the solar disaggregator 408 is considered the predicted solar production of the structure. This predicted solar production is extracted from the overall aggregate data of the structure, resulting in a non-solar aggregate data of the structure.

By using non-solar aggregate data for the unified appliance profile schema 410, the bidirectional profile registry 412, and the multi-stage statistical detection engine 414, the accuracy of the output 406 data results of the system 400 is dramatically increased. Stated another way, if the structure utilizes solar power, the input data (the non-solar aggregate data) which is provided to the unified appliance profile schema 410, the bidirectional profile registry 412, and the multi-stage statistical detection engine 414 will not include the inaccuracies that occur when solar energy production is still included in the overall aggregate data that is inputted to the unified appliance profile schema 410, the bidirectional profile registry 412, and the multi-stage statistical detection engine 414. The removal of the solar component from the overall aggregate data is desired, so that the customer's structure may be treated as if it were a non-solar structure and the resulting predictions (the outputs of the disaggregation system 400 in FIG. 4), can be more accurate.

It should also be noted that if the structure does not utilize solar power, the overall aggregate data is already considered non-solar aggregate data to be used as data inputs by the unified appliance profile schema 410, the bidirectional profile registry 412, and the multi-stage statistical detection engine 414.

Furthermore, the data output from one or more of the unified appliance profile schema 410, the bidirectional profile registry 412, and the multi-stage statistical detection engine 414 are then provided to a post-processing system 416. Specifically, the post-processing system 416 post-processes the signals of the appliances and cleans one or more sessions. The results from the cleaning of the session can then be traced, based on the one or more selected set of appliance profiles.

Turning now to FIGS. 5A and 5B, these figures provide a flow chart showing a method 500 for interval energy disaggregation utilizing profile-driven non-intrusive load monitoring, according to an example embodiment. In some embodiments, the method 500 can be performed by the system 400 described above with reference to FIG. 4.

The method 500 commences with block 510, where a determination is made whether the structure utilizes solar power. This determination can be made based on the customer data, the weather data, and/or based on a determination of whether the structure includes or is associated with a solar panel. As discussed earlier herein, the customer data 402 and weather data 404 may be obtained from any datastore or database. Typically, the customer data 402 and/or the weather data 404 are derived from data generated and furnished by a utility company, a weather service, and/or the customer itself.

If it is determined that the structure utilizes solar power at block 510, then it is presumed that solar consumption data is still included in the overall aggregate data, and the method 500 continues with optional block 512. At optional block 512, the predicted solar production is extracted from the overall aggregate data of the structure, to produce non-solar aggregate data. In some embodiments, the solar disaggregation of the overall aggregate data is accomplished by the solar disaggregator (e.g., the solar disaggregator 408 of FIG. 4). Weather features are obtained based on the structure's general location.

Alternatively, if at block 510 it is determined that the structure does not utilize solar power, then since solar consumption data is not a part of the overall aggregate data, the overall aggregate data is considered non-solar aggregate data. In this scenario, the method 500 skips optional block 512 and continues with block 514 in order to begin disaggregating the non-solar aggregate data, based on the weather data and the customer data.

At block 514, appliance profiles for a plurality of appliances of the structure are established using a unified appliance profile schema (e.g., the unified appliance profile schema 410 in FIG. 4). A profile of an appliance includes all the parameters that define the appliance's detection and validation behavior. In some embodiments, an appliance profile includes thirty or more parameters. The unified appliance profile schema provides an appliance profile system that encapsulates all appliance-specific behavior in a single, declarative structure. A non-limiting exemplary appliance profile schema is provided below:

APPLIANCE PROFILE SCHEMA

Core Identification:

| | |
|---|---|
| - name: str | # Human-readable name (e.g., “Electric Furnace”) |
| - category: str | # Primary category (e.g., “heating_primary”) |

| | |
|---|---|
| - subcategory: Optional[str] | # Secondary classification (e.g., “heat_pump”) |

Detection Parameters:

| | |
|---|---|
| - energy_range: Tuple[float, float] | # (min, max) kWh per interval |
| - duration_range: Tuple[int, int] | # (min, max) slots for valid session |

| | |
|---|---|
| - energy_threshold: float | # Minimum energy to trigger detection |
| - baseline_multiplier: float | # Adjustment factor for baseline calculation |

| | |
|---|---|
| - cycle_pattern: str | # “continuous” \| “cycling” \| “burst” \| “variable” |

Environmental Adjustments:

| | |
|---|---|
| - temperature_effect: Callable | # Function: temp_celsius −> (multiplier, additive) |
| - seasonal_factor: Callable | # Function: day_index −> multiplier |

| | |
|---|---|
| - time_of_day_effect: Callable | # Function: hour −> (multiplier, additive) |

Detection Quality:

| | |
|---|---|
| - min_component_weight: float | # Minimum GMM component weight |

| | |
|---|---|
| - max_cv: float | # Maximum coefficient of variation |

| | |
|---|---|
| - expected_max_ratio: float | # Warning threshold for detection ratio |
| - strict_energy_range: bool | # Whether to clip attributed energy |

| | |
|---|---|
| - validation_rules: List[Callable] | # Custom validation functions |

Postprocess Validation:

| | |
|---|---|
| - min_activations_per_day: float | # Minimum expected activations |

| | |
|---|---|
| - min_energy_fraction: float | # Minimum % of total energy |

| | |
|---|---|
| - max_energy_fraction: float | # Maximum plausible % of energy |
| - min_presence_confidence: float | # Confidence threshold for confirmation |

Relationships:
- mutually_exclusive_with: List[str] # Cannot coexist temporally

| | |
|---|---|
| - requires_presence_of: str | # Depends on another appliance |
| - incompatible_with: List[str] | # Cannot coexist in same building |

| | |
|---|---|
| - suggests_presence_of: List[str] | # Promotes other appliances |

- suggestion_confidence_boost: float # Boost amount for suggested appliances
Conflict Resolution:

| | |
|---|---|
| - overlap_tolerance: float | # Max acceptable temporal overlap (0-1) |
| - correlation_tolerance: float | # Max acceptable correlation (0-1) |

Seasonal Expectations:

| | |
|---|---|
| - peak_season: str | # “winter” \| “summer” \| “year_round” |

| | |
|---|---|
| - off_season_max_ratio: float | # Max detection in off-season |

Building Type Validation:

| | |
|---|---|
| - min_daily_energy_kwh: float | # Minimum building size for this appliance |

Once profiles of the plurality of appliances of the structure are established using the unified appliance profile schema, the profiles are then registered in a bidirectional profile registry (e.g., the bidirectional profile registry 412 of FIG. 4), which provides centralized, bidirectional mapping between profile names, column names, and categories. The bidirectional profile registry provides central mapping between profile names, column names, and categories. The bidirectional profile registry defines what a signal of an appliance looks like and what is the appliance's relationship with other appliances of the structure. In some embodiments, the bidirectional profile registry uses Bayesian distribution for clustering. The exemplary systems and methods try to find a cluster, which is synonymous with a session. The registry allows a marking of one or more clusters. A non-limiting exemplary profile registry is provided below:

PROFILE REGISTRY STRUCTURE

Internal Maps:

| | |
|---|---|
| profiles_by_name: Dict[str, ApplianceProfile] | # “Water Heater” −> profile |
| profiles_by_column: Dict[str, ApplianceProfile] | # “water_heater_kwh” −> profile |

| | |
|---|---|
| categories: Dict[str, List[str]] | # “heating_primary” −> [columns] |

Bidirectional Lookups:

| | |
|---|---|
| get_profile_for_column(col) −> profile | # O(1) reverse lookup |
| get_column_for_profile(name) −> col | # O(1) forward lookup |
| get_columns_for_category(cat) −> [cols] | # Category enumeration |

```
Automatic Mappings:
  profile.name = “Electric Baseboard Heater”
  → column = “electric_baseboard_heater_kwh”
  → categories[“heating_primary”] includes column
  → categories[“heating_primary_electric”] if subcategory present
```

Multiple benefits are provided by the bidirectional profile registry, including but not limited to the following:
1. Single Source of Truth: Profile changes automatically propagate to detection, validation, and conflict resolution.
2. Category-Based Operations: HVAC system selection, conflict checks operate on category groups.
3. Decoupled Components: Detection engine does not need to know column naming conventions.
4. Audit Trail: All appliance behavior is traceable to profile definition.

At block 516, some appliance profiles associated with one or more of a plurality of appliances of the structure are selected. Those selected appliance profiles are to be utilized in an upcoming disaggregation of the non-solar aggregate data. In some embodiments, the selection of appliance profiles at block 516 further comprises a determination of which appliances of the structure (and hence their respective appliance profiles) are to be disregarded for purposes of disaggregating the non-solar aggregate data. In some embodiments, such appliances to be disregarded or ignored, for purposes of disaggregating the non-solar aggregate data, may be considered as outliers. In other embodiments, those appliance profiles that present a conflict are disregarded or otherwise not selected. When appliance profiles conflict, an exemplary conflict resolution engine may be utilized to enforce profile-defined relationships and resolve detection conflicts. Pseudocode for an exemplary conflict resolution engine is provided below:

RELATIONSHIP VALIDATION ALGORITHM

```
Input: df, confirmed_appliances, registry
Output: violations (appliances to reject)
violations = { }
1. MUTUAL EXCLUSIVITY CHECK:
  FOR each confirmed appliance A:
    profile_A = registry.get_profile_for_column(A)
    FOR each name in profile_A.mutually_exclusive_with:
      B = registry.get_column_for_profile(name)
      IF B in confirmed_appliances:
        # Both detected - check temporal overlap
        overlap = calculate_overlap(df[A], df[B])
        IF overlap > profile_A.overlap_tolerance:
          # Conflict! Keep higher energy
          IF sum(df[A]) < sum(df[B]):
            violations[A] = f“mutually_exclusive_with_{B}”
          ELSE:
            violations[B] = f“mutually_exclusive_with_{A}”
2. DEPENDENCY CHECK:
  FOR each confirmed appliance A:
    profile_A = registry.get_profile_for_column(A)
    IF profile_A.requires_presence_of:
      required = registry.get_column_for_profile(profile_A.requires_presence_of)
      IF required NOT in confirmed_appliances:
        violations[A] = f“missing_required_{profile_A.requires_presence_of}”
3. INCOMPATIBILITY CHECK:
  FOR each confirmed appliance A:
    profile_A = registry.get_profile_for_column(A)
    FOR each name in profile_A.incompatible_with:
      B = registry.get_column_for_profile(name)
      IF B in confirmed_appliances:
        # Both present - keep higher energy
        IF sum(df[A]) < sum(df[B]):
          violations[A] = f“incompatible_with_{B}”
        ELSE:
          violations[B] = f“incompatible_with_{A}”
```

### Return Violations

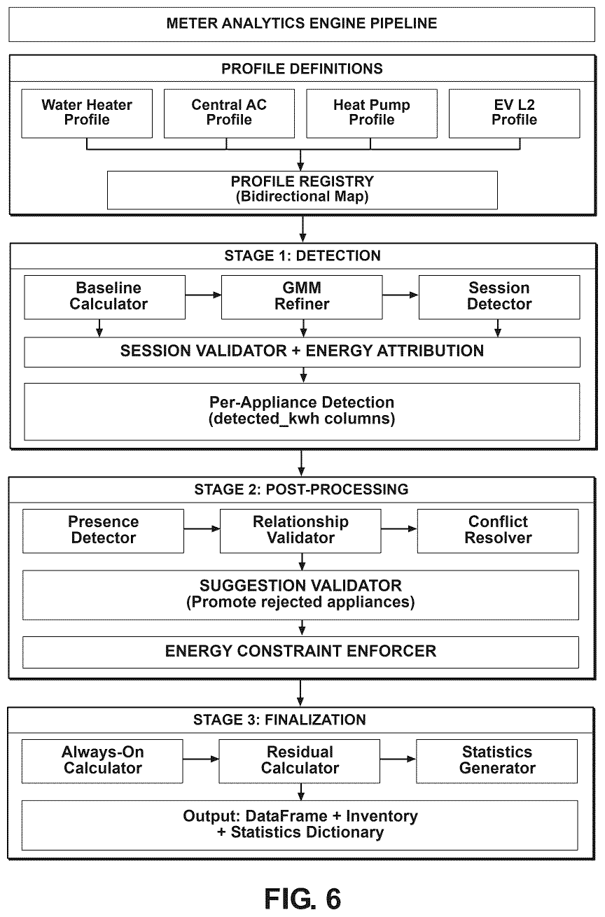

Returning to FIGS. 5A and 5B, at block 518, based on the selected set of appliance profiles, the non-solar aggregate data is disaggregated, to produce disaggregated non-solar data relating to at least one of AC energy consumption and EV (electric vehicle) consumption, respectively. In some embodiments, block 518 includes substeps 518a, 518b, and 518c. At block 518a, a session of the appliances is detected based on signals of the appliances. As mentioned earlier, a session is synonymous with a cluster, and an appliance produces a signal. Specifically, a session is a contiguous period of appliance activation. At block 518b, the selected set of appliance profiles are utilized to execute the post-processing of the signals of the appliances and the cleaning of the session. At block 518c, the results from the cleaning of the session are traced, based on the one or more selected set of appliance profiles. Those results can be part of a user-friendly explanation to be furnished to a customer or a utility. For instance, the user-friendly explanation can be based on the results to explain why a session was cleaned or what occurred during the post-processing of the signals of the appliances. Further description of the disaggregation of non-solar data will be provided later in the description of FIG. 6.

In some embodiments, a self-improvement process of the exemplary system is automatically executed. That is, as more appliance profiles are added to the exemplary system, the profile-driven non-intrusive load monitoring is enhanced, and the new data has a higher confidence in the final output providing the disaggregated data. In some embodiments, the self-improvement process comprises identifying one or more of the related appliance profiles or the most common appliance profiles, and then boosting or otherwise modifying other appliance profiles in view of the identified related or most common appliance profiles. This process is called suggestion-based appliance promotion. Such suggestion-based appliance promotion solves the technical problem where low-confidence appliances are rejected despite being strongly suggested by confirmed related appliances. The suggestion-based appliance promotion comprises profile-defined suggestion relationships with confidence boosting. An example of this is the following:

```
heat_pump_heating_profile:
  suggests_presence_of: [“Heat Pump Cooling Mode”]
  suggestion_confidence_boost: 0.25
```

Thus, in this example, if heat pump heating is confirmed, then heat pump cooling gets a confidence boost that may promote it from “rejected” to “confirmed” status. In other words, the heat pump cooling will then be selected for disaggregation of the aggregate data.

Furthermore, post-processing may occur of the overall aggregate data, including one or more of the solar production data and the non-solar aggregate data. In some embodiments, the post-processing may be of all the appliance profiles of the plurality of appliances associated with the structure. During post-processing, in some embodiments, appliance profiles may be added, deleted or otherwise modified. Also, in some embodiments, a Gaussian Mixture Model (which is a statistical model for identifying energy level clusters) is used to clean up sessions for all the appliances associated with the structure. During post-processing, further cycles of self-improvement processes may occur, to improve the exemplary system based on what appliance profiles have been added, removed, and what the exemplary system has learned based on the profile schema.

Several other aspects of the present disclosure benefit from iterative feedback loops, particularly as the amount of historical data of the appliances grows.

Returning to FIGS. 5A and 5B, the method 500 concludes with block 520, where the disaggregated data is provided to the customer or utility. The disaggregated data includes at least one or more of the predicted solar production and the non-solar production data (such as AC energy consumption and the EV consumption of the structure). The disaggregated data may be displayed on a display of a computing device of the customer or utility.

An optional block of the method 500 provides a user-friendly explanation to the customer or utility or an actual audit trail that demonstrates how the behavior of one or more of the appliances of the structure can be traced, using appliance profiles or appliance profile definition. In other words, the present disclosure provides explainability for why certain energy detections are rejected or how certain energy detections are traceable.

FIG. 6 is a block diagram of an exemplary meter analytics engine pipeline, according to some example embodiments. The meter analytics engine pipeline can be an element of the disaggregation system (e.g., the disaggregation system 400 of FIG. 4). In the meter analytics engine pipeline, appliance profiles are defined. In the exemplary meter analytics engine pipeline, the appliance profiles that are defined are as follows: a water heater profile, a central AC profile, a heat pump profile, and an EV L2 profile. All of these appliance profiles are then registered in a profile registry, which is a bidirectional profile registry or map (e.g., a the bidirectional profile registry 412 of FIG. 4). Once the appliance profiles are all registered in the profile registry, then a process of three stages occurs. The first stage is detection. In the detection stage, a session of appliances is detected based on signals of the appliances. As shown in FIG. 6, a baseline calculator, a GMM refiner, and a session detector perform their functions so that a session validator and an energy attribution component can perform their jobs based on the individual appliance profiles. As a result, a per-appliance energy detection is accomplished. In other words, at the end of the first stage, the energy consumption is determined for each appliance that had an appliance profile.

An exemplary baseline calculator is provided below:

```
Calculate global statistics:
  mean = mean(energy_np)
  std = std(energy_np)
  cv = std / mean if mean > 0 else 0
2. Select parameters based on variability:
  IF cv > 0.8: # High variability
    window_days = 3
    quantile = 0.15
  ELSE: # Low variability
    window_days = 7
    quantile = 0.10
3. Calculate window size:
  max_window = 96 * window_days # 96 slots/day
  data_fraction = len(energy) / (8 if cv > 0.8 else 4)
  window = max(3, min(max_window, data_fraction))
4. Apply rolling quantile:
  baseline = rolling_quantile(energy, window, quantile)
  baseline = forward_fill(backward_fill(baseline))
5. Apply profile multiplier:
  baseline = baseline + mean * profile.baseline_multiplier
6. Apply temperature adjustment:
  IF profile.temperature_effect:
    FOR i in range(len(baseline)):
      mult, add = profile.temperature_effect(temp_np[i])
      mult = clip(mult, 0.1, 10.0)
      add = clip(add, −1000, 1000)
      baseline[i] = baseline[i] * mult + add
7. Apply seasonal adjustment:
  IF profile.seasonal_factor:
    FOR i in range(len(baseline)):
      factor = profile.seasonal_factor(i)
      IF 0.1 <= factor <= 10.0:
        baseline[i] = baseline[i] * factor
```

RETURN baseline

A GMM threshold refiner is as follows:

```
Input: energy_np, baseline_np, initial_candidates, profile
Output: refined_threshold, on_component_means
1. Extract activation values:
  activations = energy_np[initial_candidates]
  IF len(activations) == 0:
    RETURN baseline_np + profile.energy_threshold, [ ]
2. Determine number of components:
  n_unique = len(unique(round(activations, 3)))
  n_components = min(max(2, n_unique / 3), 6)
3. Fit Bayesian GMM:
  gmm = BayesianGaussianMixture(
    n_components=n_components,
    covariance_type=“spherical”,
    max iter=1000
  )
  gmm.fit(activations.reshape(−1, 1))
4. Sort and filter components:
  comp_means, comp_weights = sorted by means ascending
  # Adaptive minimum weight
  min_weight = max(0.02, 1.0 / (n_components * 2))
  IF profile.min_component_weight IS NOT NULL:
    min_weight = profile.min_component_weight
  significant = WHERE comp_weights >= min_weight
5. Identify ON-state components:
  baseline_median = median(baseline_np)
  threshold_margin = profile.energy_threshold * 0.1
  on_components = significant WHERE mean > baseline_median + threshold_margin
6. Calculate refined threshold:
  IF len(on_components) == 0:
    RETURN baseline_np + profile.energy_threshold, [ ]
  primary_on = argmax(weight) among on_components
  base_margin = max(profile.energy_threshold, primary_on.mean * 0.25)
  # Confidence-based scaling
  weight_factor = 0.8 + 0.4 * primary_on.weight # Range: [0.8, 1.2]
  refined_margin = base_margin * weight_factor
  refined_threshold = baseline_np + refined_margin
```

RETURN Refined_Threshold, on_Components

A session detector is provided here:

```
Input: activation_indices, profile
Output: sessions (list of index lists)
1. Filter single-slot spikes:
  FOR each group of consecutive indices:
    IF len(group) == 1:
      REMOVE from activation_indices
2. Calculate profile-based gap:
  min_dur, max_dur = profile.duration_range
  SWITCH profile.cycle_pattern:
    CASE “continuous”:
      profile_gap = max(min_dur * 2, min(max_dur * 2, 24))
    CASE “cycling”:
      profile_gap = max(min_dur, min(min_dur * 3, 12))
    CASE “burst”:
      profile_gap = max(1, min_dur)
    CASE “variable”:
      profile_gap = max(2, min_dur)
3. Detect natural gap (if sufficient data):
  IF len(activation_indices) >= 5:
    gaps = diff(activation_indices)
    natural_gap = percentile(gaps, 75)
    # Bound by reasonable limits
    min_gap = max(1, min_dur / 4)
    max_gap = min(24, max_dur * 2)
    natural_gap = clip(natural_gap, min_gap, max_gap)
  ELSE:
    natural_gap = infinity
4. Select optimal gap:
  min_acceptable = max(1, profile_gap * 0.3)
  IF natural_gap >= min_acceptable:
    optimal_gap = min(profile_gap, natural_gap)
  ELSE:
    optimal_gap = profile_gap
5. Split by gap:
  sessions = [ ]
  current_session = [activation_indices[0]
  FOR i in range(1, len(activation_indices)):
    gap = activation_indices[i] − activation_indices[i−1]
    IF gap > optimal gap:
      sessions.append(current_session)
      current_session = [activation_indices[i]]
    ELSE:
      current_session.append(activation_indices[i])
  sessions.append(current_session)
6. Filter short sessions:
  sessions = [s for s in sessions if len(s) >= profile.duration_range[0]
```

### RETURN Sessions

An exemplary session validator and energy attribution component is provided here:

```
        Input: sessions, energy_np, baseline_np, temp_np, on_components, profile
Output: detected_energy
1. Initialize output:
  detected = zeros(len(energy_np))
2. FOR each session:
  session_values = energy_np[session]
  session_baseline = baseline_np[session]
  # Duration validation
  IF NOT (min_dur <= len(session) <= max_dur):
    CONTINUE
  # Energy delta validation
  session_delta = sum(session_values) − sum(session_baseline)
  avg_delta = session_delta / len(session)
  IF NOT (min_energy * 0.6 <= avg_delta <= max_energy * 1.5):
    CONTINUE
  # CV validation
  delta_values = session_values − session_baseline
  cv = std(delta_values) / avg_delta if avg_delta > 0 else infinity
  IF cv > profile.max_cv:
    CONTINUE
  # Custom validation rules
  IF profile.validation_rules:
    context = {
      “session_indices”: session,
      “raw_energy”: session_values,
      “baseline”: session_baseline,
      “temperature”: temp_np[session] if temp_np else None
    }
    FOR rule in profile.validation_rules:
      IF NOT rule(session_values, context):
        CONTINUE session_loop # Skip this session
3. Energy Attribution:
  FOR i, idx in enumerate(session):
    raw_val = energy_np[idx]
    baseline_val = baseline_np[idx]
    IF len(on_components) > 0:
      # GMM-based attribution
      distances = |raw_val − on_component_means|
      nearest_mean = on_component_means[argmin(distances)]
      raw_attr = max(0, raw_val − baseline_val)
      gmm_attr = max(0, nearest_mean − baseline_val)
      # Conservative: take minimum of estimates
      attributed = min(raw_attr, gmm_attr, profile.energy_range[1])
    ELSE:
      # Baseline-based attribution
      attributed = max(0, min(raw_val − baseline_val, profile.energy_range[1]))
    detected[idx] += attributed
4. Global clipping (if strict_energy_range):
  detected = clip(detected, 0, profile.energy_range[1])
RETURN detected
```

Then, at stage two, post-processing (such as post-processing 416 of FIG. 4) begins.

The appliance profiles are utilized to execute the post-processing of the signals of the appliances and the cleaning of the session. The post-processing stage utilizes a presence detector, a relationship validator and a conflict resolver to accomplish this. Then, a suggestion validator promotes rejected appliances, and an energy constraint enforcer can perform its job.

An exemplary presence detector is provided here:

```
Input: df (detection results), registry
Output: inventory (confirmed/rejected appliances)
FOR each appliance_column in df:
  profile = registry.get_profile_for_column(appliance_column)
  series = df[appliance_column]
  # Calculate metrics
  total_energy = sum(series)
  activation_count = count_transitions(series > 0.001)
  temporal_regularity = analyze_gap_consistency(series)
  # Calculate energy fraction based on appliance type
  IF profile.temperature_effect IS NOT NULL:
    # HVAC: use active-period energy as denominator
    active_days, active_energy = calculate_active_period(df, profile)
    energy_fraction = total_energy / active_energy
  ELSE:
    # Non-HVAC: use total energy with building-size scaling
    energy_fraction = total_energy / total_building_energy
  # Calculate confidence score
  energy_score = min(1.0, energy_fraction * 10)
  activation_score = min(1.0, activation_count / 20)
  confidence = 0.4 * energy_score + 0.4 * activation_score + 0.2 * regularity
  # Profile-driven validation
  is_valid, rejection_reason = validate_with_profile(
    series, profile, activation_count, energy_fraction, confidence, df
  )
```

An exemplary relationship validator is shown below:

```
Input: df, confirmed_appliances, registry
Output: violations (appliances to reject)
violations = { }
1. MUTUAL EXCLUSIVITY CHECK:
  FOR each confirmed appliance A:
    profile_A = registry.get_profile_for_column(A)
    FOR each name in profile_A.mutually_exclusive_with:
        B = registry.get_column_for_profile(name)
        IF B in confirmed_appliances:
          # Both detected - check temporal overlap
          overlap = calculate_overlap(df[A], df[B])
          IF overlap > profile_A.overlap_tolerance:
            # Conflict! Keep higher energy
            IF sum(df[A]) < sum(df[B]):
              violations[A] = f“mutually_exclusive_with_{B}”
            ELSE:
              violations[B] = f“mutually_exclusive_with_{A}”
2. DEPENDENCY CHECK:
  FOR each confirmed appliance A:
    profile_A = registry.get_profile_for_column(A)
    IF profile_A.requires_presence_of:
        required = registry.get_column_for_profile(profile_A.requires_presence_of)
        IF required NOT in confirmed_appliances:
          violations[A] = f“missing_required_{profile_A.requires_presence_of}”
3. INCOMPATIBILITY CHECK:
  FOR each confirmed appliance A:
    profile_A = registry.get_profile_for_column(A)
    FOR each name in profile_A.incompatible_with:
        B = registry.get_column_for_profile(name)
        IF B in confirmed_appliances:
          # Both present - keep higher energy
          IF sum(df[A]) < sum(df[B]):
            violations[A] = f“incompatible_with_{B}”
          ELSE:
            violations[B] = f“incompatible_with_{A}”
RETURN violations
      An exemplary conflict resolver is shown here:
Input: df, confirmed_appliances, registry
Output: df_resolved
FOR each pair (A, B) in confirmed_appliances:
  profile_A = registry.get_profile_for_column(A)
  # Get thresholds
  corr_threshold = profile_A.correlation_tolerance or 0.7
  overlap_threshold = profile_A.overlap_tolerance or 0.6
  # Calculate correlation
  correlation = pearson_correlation(df[A], df[B])
  overlap = calculate_temporal_overlap(df[A], df[B])
  IF correlation > corr_threshold AND overlap > overlap_threshold:
    # High correlation conflict - keep higher energy
    IF sum(df[A]) >= sum(df[B]):
        df[B]= 0
    ELSE:
        df[A] = 0
```

### RETURN df

An exemplary suggestion validator is provided here:

```
          # Scenario: Heat Pump Heating confirmed suggests Heat Pump Cooling
# If HP Cooling was rejected for low_confidence, boost it
Input: df, inventory, registry
Output: promotions
promotions = { }
FOR each confirmed appliance A:
  profile_A = registry.get_profile_for_column(A)
  IF profile_A.suggests_presence_of:
    FOR suggested_name in profile_A.suggests_presence_of:
      B = registry.get_column_for_profile(suggested_name)
      IF B in inventory.rejected_appliances:
        rejection_reason = inventory.rejected_appliances[B]
        # Only boost low_confidence rejections
        IF rejection_reason.startswith(“low_confidence”):
            original_confidence = inventory.presence_analysis[B].confidence
            boosted_confidence = original_confidence + profile_A.suggestion_confidence_boost
            profile_B = registry.get_profile_for_column(B)
            threshold = profile_B.min_presence_confidence
            IF boosted_confidence >= threshold:
              promotions[B] = {
                “original”: original_confidence,
                “boosted”: boosted_confidence,
                “suggested_by”: A
              }
RETURN promotions
```

An energy constraint enforcer may look like this:

```
Input: df, confirmed_appliances
Output: df_constrained
1. INTERVAL-LEVEL CONSTRAINT:
  # Sum of appliances cannot exceed total consumption at any interval
  detection_sum = sum_horizontal(df[confirmed_appliances])
  FOR each interval WHERE detection_sum > corrected_consumption:
    scale_factor = corrected_consumption / detection_sum
    FOR each appliance A:
      df[A] = df[A] * scale_factor
2. GLOBAL ATTRIBUTION CONSTRAINT:
  # Total attributed energy cannot exceed 85% of consumption
  total_detected = sum(df[confirmed_appliances])
  total_consumption = sum(df[“corrected_consumption_kwh”])
  attribution_ratio = total_detected / total_consumption
  IF attribution_ratio > 0.85:
    scale_factor = 0.85 / attribution_ratio
    FOR each appliance A:
      df[A] = df[A] * scale_factor
RETURN df
```

Then, at stage three, finalization occurs. Here, results are traced from the cleaning of the session, based on the one or more selected set of appliance profiles. Using an Always-On calculator, a residual calculator, and a statistics generator, the pipeline provides an output of dataframe+inventory+statistics dictionary.

It will be understood that the descriptions and elements of FIGS. 4, 5A, 5B and 6 can be combined, added, included, removed, changed, enhanced, merged, or otherwise modified using the descriptions and elements of FIGS. 1-3, and the scope of the invention is not limited solely to what is depicted in a figure independent from the other figures. As a non-limiting example, the method steps as depicted in FIGS. 5A and 5B and described herein can be combined, removed, changed, replaced, added, or otherwise modified with the steps of any other method also described herein. Also, any of the system figures of the present disclosure (including, but not limited to, FIGS. 1, 4 and 6) can be implemented in a computing system of FIG. 3, in accordance with some embodiments.

What is claimed is:

1. A method for interval energy disaggregation utilizing profile-driven non-intrusive load monitoring, the method comprising:
based on customer data pertaining to a customer associated with the structure, determining whether the structure utilizes solar energy that is generated by a solar panel associated with a structure, the customer data further comprising overall aggregate data of the structure generated by an advanced meter infrastructure of a utility, the overall aggregate data comprising consumption data regarding energy usage of the customer at the structure;
extracting predicted solar production, if any, from the overall aggregate data of the structure, to produce non-solar aggregate data for the structure;
establishing appliance profiles for one or more of a plurality of appliances of the structure using a unified appliance profile schema, the unified appliance profile schema configured to encapsulate all appliance-specific behavior in a persistent single, declarative profile structure;
selecting a set of the appliance profiles;
based on the selected set of appliance profiles, disaggregating the non-solar aggregate data, to produce disaggregated data relating to at least one of AC energy consumption and EV (electric vehicle) consumption, comprising:
detecting a session of a set of appliances based on the signals of the appliances;
utilizing the selected set of appliance profiles to execute the post-processing of the signals of the set of appliances and cleaning of the session; and
tracing results from the cleaning of the session, based on the one or more selected set of appliance profiles; and
providing the disaggregated non-solar aggregate data to the customer or the utility, the disaggregated non-solar aggregate data comprising at least one of the AC energy consumption, and the EV consumption associated with the structure.

2. The method of claim 1, further comprising providing the predicted solar production to the customer or the utility.

3. The method of claim 1, further comprising registering, via a bidirectional profile registry, the appliance profiles for the one or more of a plurality of appliances of the structure.

4. The method of claim 1, wherein determining whether the structure utilizes solar energy is based on weather data.

5. The method of claim 1, further comprising performing post-processing of the disaggregated data.

6. The method of claim 1, wherein performing post-processing of the disaggregated data further comprises adding, removing, or modifying the one or more of the plurality of appliances.

7. The method of claim 1, wherein the selecting a set of appliance profiles further comprises determining which appliance profiles are to be ignored or disregarded.

8. The method of claim 1, further comprising automatically executing a self-improvement process.

9. The method of claim 8, wherein the self-improvement process comprises:
determining profile-defined suggestion relationships of the one or more of the plurality of appliances; and
based on the profile-defined suggestion relationships, confidence boosting the one or more of the plurality of appliances.

10. A system for interval energy disaggregation utilizing profile-driven non-intrusive load monitoring, the system comprising:
a memory for storing executable instructions; and
a processor coupled to the memory, the processor configured to execute the executable instructions to:
based on customer data pertaining to a customer associated with the structure, determine whether the structure utilizes solar energy that is generated by a solar panel associated with a structure, the customer data further comprising overall aggregate data of the structure generated by an advanced meter infrastructure of a utility, the overall aggregate data comprising consumption data regarding energy usage of the customer at the structure;
extract predicted solar production, if any, from the overall aggregate data of the structure, to produce non-solar aggregate data for the structure;
establish appliance profiles for one or more of a plurality of appliances of the structure using a unified appliance profile schema, the unified appliance profile schema configured to encapsulate all appliance-specific behavior in a persistent single, declarative profile structure;
select a set of the appliance profiles;
based on the selected set of appliance profiles, disaggregate the non-solar aggregate data, to produce disaggregated data relating to at least one of AC energy consumption and EV (electric vehicle) consumption, comprising:
detect a session of a set of appliances based on the signals of the appliances;
utilize the selected set of appliance profiles to execute the post-processing of the signals of the set of appliances and cleaning of the session; and
trace results from the cleaning of the session, based on the one or more selected set of appliance profiles; and
provide the disaggregated non-solar aggregate data to the customer or the utility, the disaggregated non-solar aggregate data comprising at least one of the AC energy consumption and the EV consumption associated with the structure.

11. The system of claim 10, wherein the processor is further configured to execute the executable instructions to provide the predicted solar production to the customer or the utility.

12. The system of claim 10, wherein the processor is further configured to execute the executable instructions to register, via a bidirectional profile registry, the appliance profiles for the one or more of a plurality of appliances of the structure.

13. The system of claim 10, wherein the processor is further configured to execute the executable instructions to determine whether the structure utilizes solar energy is based on weather data.

14. The system of claim 10, wherein the processor is further configured to execute the executable instructions to perform post-processing of the disaggregated data.

15. The system of claim 14, wherein the post-processing of the disaggregated data further comprises adding, removing, or modifying the one or more of the plurality of appliances.

16. The system of claim 10, wherein the selection of a set of appliance profiles further comprises determining which appliance profiles are to be ignored or disregarded.

17. The system of claim 10, wherein the processor is further configured to execute the executable instructions to automatically execute a self-improvement process.

18. The system of claim 17, wherein the self-improvement process comprises:
determining profile-defined suggestion relationships of the one or more of the plurality of appliances; and
based on the profile-defined suggestion relationships, confidence boosting the one or more of the plurality of appliances.

19. A non-transitory computer readable medium for having embodied thereon instructions, which when executed by a processor, perform steps of a method for interval energy disaggregation utilizing profile-driven non-intrusive load monitoring, the method comprising:
based on customer data pertaining to a customer associated with the structure, determining whether the structure utilizes solar energy that is generated by a solar panel associated with a structure, the customer data further comprising overall aggregate data of the structure generated by an advanced meter infrastructure of a utility, the overall aggregate data comprising consumption data regarding energy usage of the customer at the structure;
extracting predicted solar production, if any, from the overall aggregate data of the structure, to produce non-solar aggregate data for the structure;
establishing appliance profiles for one or more of a plurality of appliances of the structure using a unified appliance profile schema, the unified appliance profile schema configured to encapsulate all appliance-specific behavior in a persistent single, declarative profile structure;
selecting a set of the appliance profiles;
based on the selected set of appliance profiles, disaggregating the non-solar aggregate data, to produce disaggregated data relating to at least one of AC energy consumption and EV (electric vehicle) consumption, comprising:
detect a session of a set of appliances based on the signals of the appliances;
utilize the selected set of appliance profiles to execute the post-processing of the signals of the set of appliances and cleaning of the session; and
trace results from the cleaning of the session, based on the one or more selected set of appliance profiles; and
providing the disaggregated non-solar aggregate data to the customer or the utility, the disaggregated non-solar aggregate data comprising at least one of the AC energy consumption and the EV consumption associated with the structure.

20. The non-transitory computer readable medium of claim 19, wherein the method further comprises registering, via a bidirectional profile registry, the appliance profiles for one or more of a plurality of appliances of the structure.
